(19) United States
(12) Patent Application Publication
(10) Pub. No.: US 2014/0189718 A1
(43) Pub. Date: Jul. 3, 2014

(54) GATEWAY SERVER AND METHOD FOR PROVIDING PERSONALIZED SERVICES

(71) Applicant: ALTICAST CORPORATION, SEOUL (KR)

(72) Inventor: Taekwan Lee, Seoul (KR)

(73) Assignee: ALTICAST CORPORATION, Seoul (KR)

(21) Appl. No.: 14/142,085

(22) Filed: Dec. 27, 2013

(30) Foreign Application Priority Data
Dec. 27, 2012 (KR) 10-2012-0155313

(51) Int. Cl. H04N 21/436; H04N 21/2543; H04N 21/462; H04N 21/214; H04N 21/458

(52) U.S. Cl. CPC H04N 21/43615; H04N 21/2143; H04N 21/458; H04N 21/462; H04N 21/2543
USPC 725/5; 725/46; 725/25

(57) ABSTRACT

A gateway server and a method of providing personalized services are disclosed. The gateway server can store settings information for each client device, and when a client device is connected, the gateway server can transmit menus and programs to the client device after filtering and recreating the menus and programs according to the settings information for the client device.

### CROSS-REFERENCE TO RELATED APPLICATIONS

This application claims the benefit of Korean Patent Application No. 10-2012-0155313, filed with the Korean Intellectual Property Office on Dec. 27, 2012, the disclosure of which is incorporated herein by reference in its entirety.

### BACKGROUND

1. Technical Field

The present invention relates to a gateway server, more particularly to a gateway server and a method of providing personalized services that can provide each of a multiple number of connected client devices with menus, programs, etc., that are reconstructed differently according to the individual settings for each client device.

2. Description of the Related Art

There is an ever-increasing number of contents and services, etc., provided to users by content providers or broadcast operators, as well as an increase in the demand of users in one home for the providing of contents and services through several devices. As such, content providers are studying ways to meet such demands by utilizing gateway servers, set-top boxes (STB's) and IP (Internet protocol) devices.

FIG. 1 illustrates an example of a home network system.

Referring to FIG. 1, a home network system may include a gateway server 101 and an IP device 103. The gateway server 101 may serve to receive broadcast contents from a headend (not shown) and distribute it to IP devices 103. QAM signals provided by a content provider may be received through the headend by the gateway server 101. From among the broadcast contents included in the QAM signals, only the contents required by an IP device 103 can be distributed by the gateway server 101 through an IP network to the IP device 103.

For example, the gateway server 101 can transmit a list of broadcast contents that can be provided by the gateway server 101 as well as information on the broadcast contents to the IP device 103, and afterwards, the broadcast contents requested by the IP device 103 can be distributed to the IP device 103.

A home network system such as that shown in FIG. 1 can offer an economic advantage, because if a family wishes to be supplied with a broadcast content through multiple devices, it may not be necessary for all of the IP devices 103 to be equipped with the hardware and software for receiving QAM signals.

In order to implement a home network system, the gateway server 101 and the IP device 103 may require a designated specification. For example, specifications may have to be designated for the method by which the list of contents that can be supplied by the gateway server 101 is shared with the IP device 103, the transmission protocol of the contents, the method by which the IP device 103 requests contents from the gateway server 101, and the like.

Industrially, the DLNA (Digital Living Network Alliance) is standardizing and defining such specifications. In the specifications drafted by the DLNA, a device that performs the functions of the gateway server is referred to as a DMS (Digital Media Server), and a device that performs the functions of the IP device is referred to as a DMP (Digital Media Player).

By using a home network system such as that described above, an N-screen service can be provided to multiple IP devices easily within a home. However, as the same programs are provided to all of the IP devices according to the conditions configured in the gateway server itself, underage children may indiscreetly gain access to real-time or on-demand programs and frequently be exposed to inappropriate information.

### SUMMARY

An aspect of the invention is to provide a gateway server and a method of providing personalized services with which menus and programs can be recreated (or filtered) at the gateway server according to the settings conditions of each client device before they are provided to the client device.

Thus, an embodiment of the invention can restrict access to certain menus or programs according to the client device, to prevent young children, etc., from indiscreetly gaining access to real-time or on-demand programs.

Also, an aspect of the invention is to provide a gateway server and a method of providing personalized services with which the authority to pay for menus or programs is configured differently for each client device, so that young children are restricted from purchasing and viewing charged programs.

An aspect of the invention provides an apparatus that can provide menus and programs that are recreated according to the settings of each client device.

One embodiment of the invention can provide a gateway server which is installed in a home and which is configured to receive live or on-demand programs according to a pre-configured schedule from a headend connected through a network and transmit the received program to one or more client devices positioned in the home. The gateway server includes: a settings unit, which stores settings information for each of the one or more client devices, where the settings information includes at least one of menus and programs that are available to the respective client devices or are to be blocked to the respective client devices, time information regarding a time during which access is permitted, authorization for payment for a menu or program, viewing restriction age, and viewing time; and a program provider unit, which filters and recreates menus and programs according to the settings information for a connected client device, when the one or more client devices are connected, and provides the recreated menus and programs to the client device.

Another aspect of the invention provides a method that can provide menus and programs that are recreated according to the settings of each client device.

An embodiment of the invention can provide a method of providing personalized services at a gateway server, which is installed in a home and which is configured to receive live or an on-demand programs according to a pre-configured schedule from a headend connected through a network and transmit the received program to one or more client devices positioned in the home. The method includes: storing settings information for each of the one or more client devices, where the settings information includes at least one of menus and programs that are available to the respective client devices or are to be blocked to the respective client devices, time information regarding a time during which access is permitted, authorization for payment for a menu or program, viewing restriction age, and viewing time; and filtering and recreating menus and programs according to the settings information for a connected client device, when the one or more client devices are connected, and providing the recreated menus and programs to the client device.

With personalization gateway server and the method of providing personalized services according to an embodiment of the invention, the gateway server can recreate menus and programs according to the settings of each client device before they are provided.

Because of this, an embodiment of the invention can restrict access to certain menus and programs according to each client device, to prevent young children, etc., from indiscreet exposure to real-time or on-demand programs.

Also, an embodiment of the invention can set the authorization level for payment for menus or programs differently according to each client device, to restrict young children's purchasing and viewing of charged programs.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 illustrates an example of a home network system.

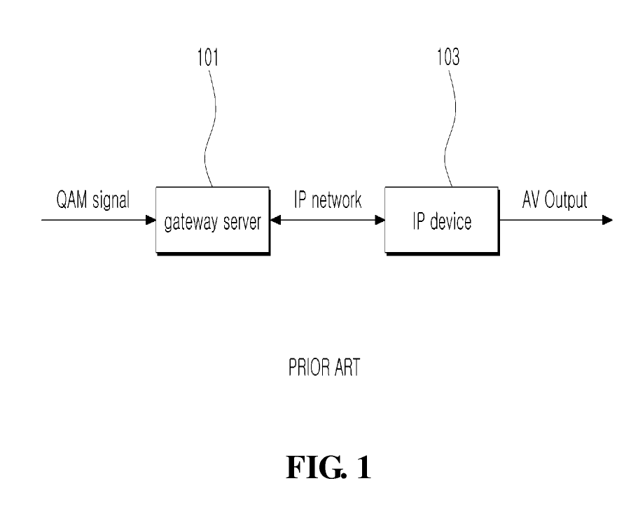

FIG. 2 illustrates the composition of a system for providing broadcast services according to an embodiment of the invention.

FIG. 3 is a block diagram schematically illustrating the internal composition of a gateway server according to an embodiment of the invention.

FIG. 4 is a flowchart illustrating the procedures by which individual settings information is configured for a client device according to an embodiment of the invention.

FIG. 5 is a flow diagram illustrating a method of configuring settings information for a client device according to another embodiment of the invention.

FIG. 6 is a flowchart illustrating a method of providing personalized services according to an embodiment of the invention.

FIG. 7 is a flow diagram illustrating a method of providing personalized services according to another embodiment of the invention.

### DETAILED DESCRIPTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In describing the invention, detailed explanations of relevant known technology will be omitted, if it is deemed that such explanations obscure the essence of the invention.

While such terms as “first” and “second,” etc., may be used to describe various components, such components must not be limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

Certain embodiments of the invention will be described below in more detail with reference to the accompanying drawings.

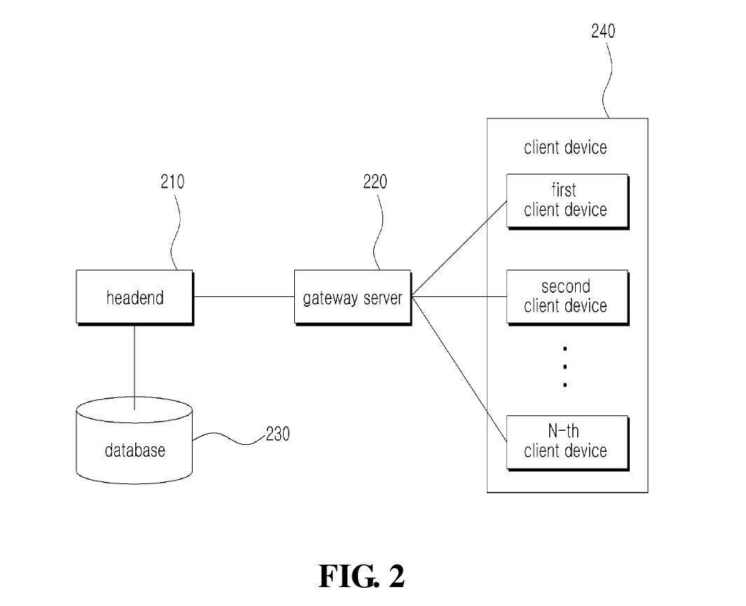

FIG. 2 illustrates the composition of a system for providing broadcast services according to an embodiment of the invention.

As illustrated in FIG. 2, a system for providing broadcast services according to an embodiment of the invention can include a headend 210 and a gateway server 220 that is connected with the headend 210 over a network.

The headend 210 may serve to provide live programs or on-demand programs according to a pre-configured schedule.

The headend 210 may convert audio and video signals (hereinafter referred to as “AV signals”) for various broadcast channels into a pre-configured format, and may transmit the converted broadcast signals to the gateway server 220.

Also, the headend 210 may receive the AV data for on-demand programs and information related to the on-demand programs from multiple content providers and may store them in a database 230. Here, the information related to the on-demand programs can include descriptions of the on-demand programs.

The gateway server 220 may serve to receive on-demand or live programs from the headend 210 and distribute the on-demand or live programs according to the request of each client device. As illustrated in FIG. 2, the on-demand or live programs requested simultaneously or differentially by multiple client devices 240 can be distributed by the gateway server 220 to the corresponding client devices 240.

Preferably, a gateway server 220 according to an embodiment of the invention can be a set-top box (gateway set-top box) capable of receiving and processing broadcast signals transmitted from a headend 210, and the multiple client devices 240 can be located near the set-top box to allow use of broadcast services.

This arrangement can be defined as a multi-room broadcast service.

A gateway server 220 according to an embodiment of the invention may be installed within a home, may receive and store settings information for multiple client devices 240 according to manipulation by a user (e.g. a parent), and may allow users to use broadcast services simultaneously or differentially on the multiple client devices 240 according to the settings information. A gateway server 220 according to an embodiment of the invention may collectively control the authorization for using broadcast services on the multiple client devices 240 located within the home.

A gateway server 220 according to an embodiment of the invention, in distributing the on-demand or live programs to each of the client devices 240, can filter the menus or programs according to the settings information of the respective client devices 240.

For example, the gateway server 220 may store the settings information for each client device. Accordingly, when a particular client device accesses the gateway server 220, the settings information regarding the authorization for use of the corresponding client device can be checked, and afterwards, the menus or programs can be filtered according to the settings information before they are recreated and transmitted to the corresponding client device.

For example, the gateway server 220 can receive broadcast schedule information (e.g. an electronic program guide, EPG) for the real-time or on-demand programs that can be provided through the headend 210. Here, the gateway server 220 can recreate the broadcast schedule information according to the settings information of the client device connecting to the gateway server 220 and transmit the broadcast schedule information to the corresponding client device.

For example, suppose that the settings information for an arbitrary client device is configured such that the accessible program is “Pororo (a children's program)”. When the client device gains access, the gateway server 220 may filter everything in the broadcast schedule information except “Pororo”, recreate a menu and program list for viewing “Pororo”, and transmit the menu and program list to the corresponding client device. Accordingly, a user at the corresponding client device may check the menu and program list for viewing “Pororo” and make a selection, to be provided with an on-demand program for Pororo via the gateway server 220 for playing on the client device. The menu and program list can include one or more menus and/or one or more programs.

That is, in the present disclosure, it should be appreciated that the concepts of filtering and recreating menus or programs encompasses the filtering and recreating of broadcast schedule information.

After checking the menu or program list that was recreated according to the settings information of the client device, a user of the client device can request and be provided with a particular on-demand or live program. In this way, the gateway server 220 may store and manage the settings information for each client device, and may filter and recreate the menus and programs that are allowed access from each client device, providing the benefit of preventing minors and teens from accessing harmful programs at the source.

Here, the settings information regarding the authorization for use can include times at which a particular client device may output at least one of a particular menu and programs. In another example, the settings information regarding the authorization for use can include authorization for use in relation to accessible menus or programs for each client device or a list of menus or programs that are allowed access at each client device. In another example, the settings information regarding the authorization for use can include a list of menus or programs that are to be blocked at each client device.

In still another example, the settings information regarding the authorization for use can also include an authorization for payment and a required age for payment at each client device, or a list of programs for which payment can be made. Of course, the settings information regarding the authorization for use can also include a list of programs for which payment cannot be made or age information regarding the age for which access is denied to the programs included in such a list.

In yet another example, the settings information regarding the authorization for use can further include information on channels that can be accessed at each client device.

In addition to the above, the settings information regarding the authorization for use can also include an authorization for data sharing and the types of data that can be shared (e.g. audio, video, image, text files, etc.).

As the gateway server 220 thus stores and manages the settings information for each client device, when users gain access from different client devices located in their respective rooms within the home, the menus or programs can be filtered and recreated according to the settings information of each client device before they are provided to the client device.

As described above, the gateway server 220 can be a typical TV or a set-top box, but is not limited thereto. The gateway server 220 can include any device capable of receiving broadcast signals, such as a smart phone, a tablet PC, a desktop PC, etc. The descriptions that follow will use an example in which the gateway server 220 is a set-top box connected to a TV that functions as the display unit.

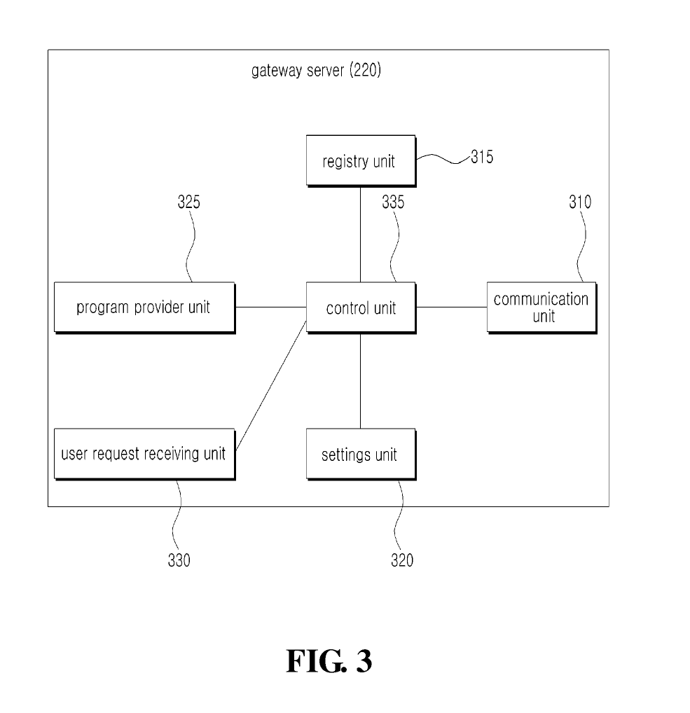

FIG. 3 is a block diagram schematically illustrating the internal composition of a gateway server according to an embodiment of the invention.

Referring to FIG. 3, a gateway server 220 according to an embodiment of the invention may include a communication unit 310, a registry unit 315, a settings unit 320, a program provider unit 325, a user request receiving unit 330, and a control unit 335.

The communication unit 310 may be coupled with at least one of the client device 240 and the headend 210 to transmit and receive data via wired or wireless communication.

For example, the communication unit 310 may transmit a request for a particular real-time or on-demand program to the headend 210, receive the corresponding real-time or on-demand program in an encoded form, and output it to the menu and program provider unit 325.

The registry unit 315 may serve to receive registration regarding the client devices that will output real-time or on-demand programs through the gateway server 220. For example, the registry unit 315 can register and store device information regarding at least one client device 240. Here, the device information can be identification information for identifying the client devices and can include, for example, a device ID, a MAC address, etc. Of course, if a client device is a mobile communication terminal, the device information can include a telephone number.

The settings unit 320 may serve to receive and manage settings information for registered client devices.

For example, the settings unit 320 can be configured with at least one of time information regarding times during which connection is permitted, authorization for use of certain menus or programs (real-time or on-demand programs), and authorization for data sharing for a client device 240, as settings information.

Here, the time during which connection is permitted can be the time during which a connection to the client device 240 itself is permitted, such as, for example, times during which the client device 240 can connect to the gateway server 220. While it is assumed herein, for easier understanding and explanation, that the information regarding times during which connection is permitted for a client device is configured, it is also possible to configure times during which connection is restricted, and it is also possible to further store the connection-restricted time together with the connection-permitted time as settings information.

The authorization for use of menus or programs involves menus or programs that can be accessed by the corresponding client device 240, and can be stored in the form of a list of accessible menus and programs. To this end, the settings unit 320 can provide a list of all menus or programs that can be provided by the gateway server 220, receive selections by the user as regards which menu or program items a particular client device 240 is permitted to access, and store such selections as settings information. Here, the menu or program items can be individual units of menus or programs, but can also be category items for menus or programs.

Also, the authorization for use of a program can include an age restriction for allowing access to the program or a viewing time restriction.

In this case, the gateway server 220 can perform a user confirmation or verification procedure according to the request of each client device 240. For example, suppose a child is watching TV in the living room. The gateway server 220 may request user confirmation or verification, and the child can input pre-registered identification information through a remote control. Then, the gateway server 220 can use the identification information to confirm and verify the user, check whether or not the verified user is of an age to which access of the program is permitted or check whether or not it is a time during which the user is permitted to view the program, and provide the corresponding menu or program to the client device 240.

The method of configuring the settings information for each client device may be substantially the same as the method of configuring the settings information for each user, and as such, redundant descriptions are omitted.

A menu can be a sub-level menu included in a particular program. Here, a sub-level menu refers to a menu that is subordinate to a particular program or a particular category. For example, suppose a particular program is “Math with Pororo”. A sub-level menu can be a menu provided by the program, where the theme of each chapter, such as “Concept of Numbers”, “Shapes and Figures”, etc., can be a first sub-level menu, and each first sub-level menu can have its own sub-menus, such as “Video Learning” and “Review”.

In another example, a sub-level menu can also represent a sub-menu for a particular category. For example, consider a category for a TV series. The sub-menus (i.e. sub-level menus) for the TV series category can be configured to show TV series according to country, such as American TV series, Korean TV series, Japanese TV series, etc. Then, channels can be included as sub-menus for the above sub-level menus. Thus, a sub-level menu can be understood as a sub-menu that is subordinate to a particular program or a particular category.

In the present disclosure, it is assumed that the authorization for use of menus or programs is represented by a list of menus or programs to which a particular client device is allowed access, but it is also possible to have the authorization for use of menus or programs be represented by a list of menus or programs to which a the client device is forbidden access.

Also, the authorization for use of menus or programs can further include authorization for payment for charged programs. The authorization for payment for charged programs can be configured for each individual charged program, for all charged programs, or for categories of charged programs.

For example, such categories can be divided according to the genre of programs (e.g. movies, TV series, games, etc.). Also, in addition to the matter of whether or not payment is permitted, the authorization for payment can include a restriction on the age that is permitted to pay for a program.

An authorization for data sharing can represent either an authorization for allowing access to data shared by another client device or an authorization for allowing the sharing of certain data with another client device.

For easier understanding and explanation, the descriptions in the present disclosure focus on an example in which it is assumed that the gateway server 220 stores the settings information for each client device that is received from a user. However, it is also possible to have the gateway server 220 receive the settings information and transmit it to the headend 210 to be stored, depending on the method of implementation.

Obviously, the settings information configured for each client device can be transmitted to the gateway server 220 by the user through an outside server (not shown) to be stored and managed by the settings unit 320 or by the headend 210.

The program provider unit 325 may determine whether or not to permit a connection and whether or not to output a menu or program, according to the settings information configured for the client device, at the request of the client device, and may provide a menu or program to the client device 340 accordingly.

For example, at the request of the client device, the program provider unit 325 can check the settings information configured for the client device and recreate the menus or programs according to the settings information before outputting it to the client device 240.

In this case, the client device 240 can be provided with only the menus and programs to which access is permitted, according to the settings information of the client device 240, and can display only such menus and programs, so that there is the advantage of blocking access to forbidden menus or programs beforehand at the source.

In another example, if a connection-permitted time is configured in the settings information of a client device 240, the program provider unit 325 may determine whether or not the time of request of the client device 240 is within the connection-permitted time. If it is within the connection-permitted time, the program provider unit 325 may permit the connection of the client device 240. However, if it is not within the connection-permitted time, the program provider unit 325 may not permit the connection of the client device 240. In this case, the program provider unit 325 can output a pre-configured alert message (e.g. an alert message indicating that connection is not permitted at the present time, etc.) to the client device 240.

In yet another example, if the request from the client device 240 is a permission request for data sharing, the program provider unit 325 may check the settings information of the client device 240 for an authorization for data sharing. The program provider unit 325 can check the data sharing authorization configured in the settings information of the client device 240 and determine whether or not to permit data sharing.

The user request receiving unit 330 may serve to receive a request from the user by way of a remote control, etc. For example, the user request receiving unit 330 can include an infrared communication module to receive the user's request.

In addition, the gateway server 220 can further include a memory for storing information related to the menus or programs provided through the gateway server 220.

The control unit 335 may serve to control the internal components (e.g. the communication unit 310, registry unit 315, settings unit 320, program provider unit 325, user request receiving unit 330, etc.) of a gateway server 220 according to an embodiment of the invention.

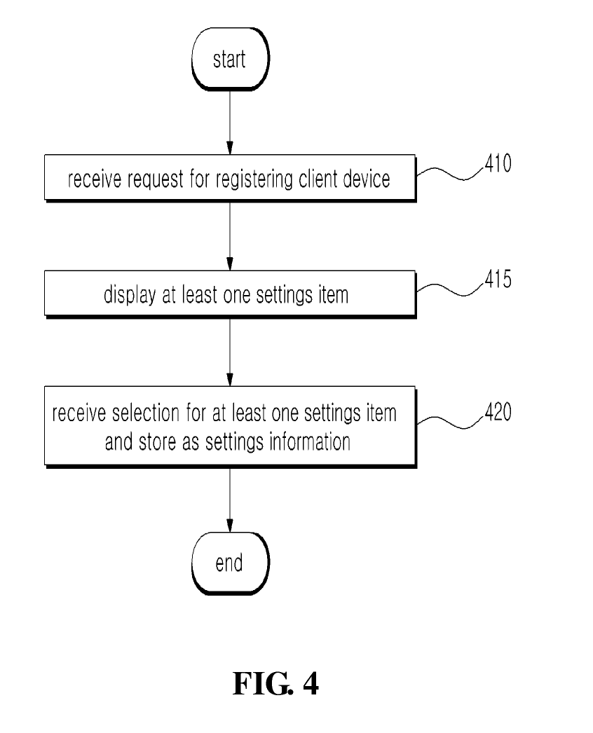

FIG. 4 is a flowchart illustrating the procedures by which individual settings information is configured for a client device according to an embodiment of the invention. For easier understanding and explanation, FIG. 4 will follow the procedures by which the gateway server 220 registers a client device by way of a remote control, etc., and receives settings information configured for each client device. While each operation described below is performed by an internal component of the gateway server 220, the entity performing the operation will be referred to simply as the gateway server for easier understanding and explanation.

In operation 410, the gateway server 220 may receive a registration request for a client device from the user.

For example, the gateway server 220 can receive a client device registration request through the user's manipulation on a remote control, etc. Here, the registration request of a client device can include identification information for the client device. As described above, the client device identification information can include an ID or a MAC address.

Although it is assumed that a registration request is received for one client device in operation 410, the client device registration request can be for multiple client devices.

In operation 415, the gateway server 220 may output the settings items for the client device. For easier understanding and explanation, it will be assumed that the gateway server 220 is connected with a client device (e.g. a TV) that is directly coupled physically in addition to the client device for which registration is requested. For easier understanding and explanation, the client device directly coupled with the gateway server 220 is referred to herein as a main client device. That is, the gateway server 220 can display the settings items through the main client device.

The settings items can be the items for configuring the settings information of each client device and can include at least one of a connection-permitted time, a menu or program list, a list of programs for which the authorization level for payment is to be configured, and an authorization for data sharing, for example.

In operation 420, the gateway server 220 may receive the settings for at least one of the settings items, by way of the user's manipulation of the remote control, and may store this as settings information.

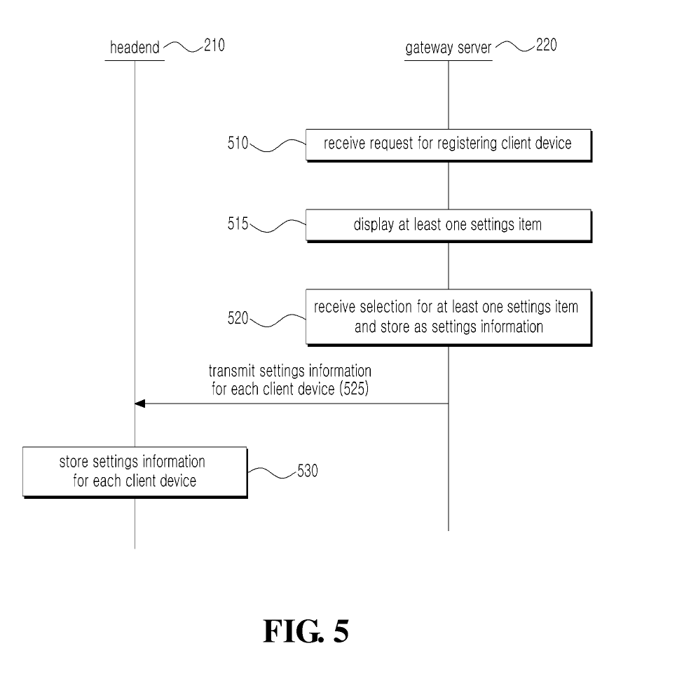

Although the present disclosure is provided, for easier understanding and explanation, with reference to an example in which the settings information is configured for each client device, it is obvious that settings information can be inputted and configured for each user as well. FIG. 5 is a flow diagram illustrating a method of configuring settings information for a client device according to another embodiment of the invention.

Operations 510 to 515 of FIG. 5 are the same as operations 410 to 415, and as such, redundant descriptions are omitted.

In operation 520, the gateway server 220 may selectively receive at least one of the settings items to configure the settings information.

Then, the gateway server 220 may transmit the corresponding settings information to the headend 210 (operation 525), instead of storing it on the gateway server 220.

In operation 530, the headend 210 may store and manage the settings information for each client device received from the gateway server 220.

Thus, by having the headend 210 store the settings information for the client devices, any unintended deletion of the settings information for the client devices can be prevented even if the gateway server 220 is initialized or subject to an error.

In another embodiment, the gateway server 220 can receive the settings information for the client devices from an outside server, and can have the settings information stored in the gateway server 220 or in the headend 210.

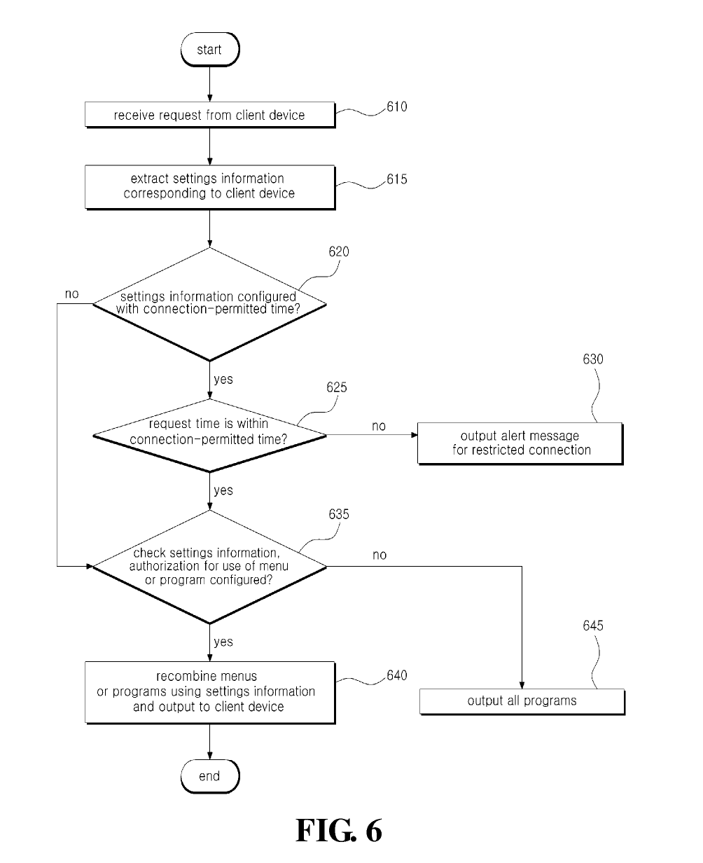

FIG. 6 is a flowchart illustrating a method of providing personalized services according to an embodiment of the invention. FIG. 6 will be described using an example in which it is assumed that the settings information for each client device is stored in the gateway server.

In operation 610, the gateway server 220 may receive the request of the client device. Here, the request can be a request for connecting to the gateway server 220 or a request for providing a menu or program.

In operation 615, the gateway server 220 may extract the settings information corresponding to the client device.

Then, in operation 620, the gateway server 220 may check the extracted settings information corresponding to the client device to check whether a connection-permitted time has been configured.

If there is no connection-permitted time configured, then the method may proceed to operation 635.

If a connection-permitted time is configured, then in operation 625, the gateway server 220 may determine whether or not the request time is within the connection-permitted time.

If the time is not within the connection-permitted time, then in operation 630, the gateway server 220 may output a pre-configured alert message through the client device, notifying the user of the connection restriction.

However, if the time is within the connection-permitted time, then in operation 635, the gateway server 220 may check the settings information and determine whether or not the use of the menu or program is authorized.

As described above, the authorization for use of a menu or program can involve information on a list of menus or programs to which access is permitted on the client device.

Accordingly, if the settings include a configuration on an authorization for using the menu or program, then in operation 640, the gateway server 220 may recreate the menu or program according to the authorization for use of the corresponding menu or program and may output it on the client device 240.

However, if the settings do not include any particular configuration on an authorization for using the menu or program, then in operation 645, the gateway server 220 may output the entire menu or program information on the client device 240 according to the conventional method.

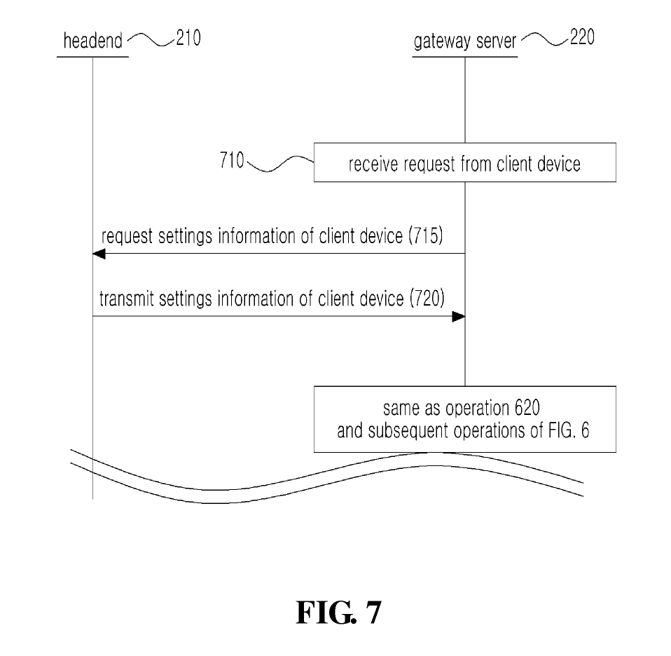

FIG. 7 is a flow diagram illustrating a method of providing personalized services according to another embodiment of the invention.

In operation 710, the gateway server 220 may receive a request from a client device.

Accordingly, in operation 715, the gateway server 220 may transmit a request for the settings information of the client device to the headend 210. Here, the request for the settings information of the client device can include identification information for the client device. According to the implementation method, the request for the settings information of the client device can further include identification information of the gateway server, to identify the gateway server 220.

Then, in operation 720, the headend 210 may search for the client device's settings information in response to the request for the settings information of the client device from the gateway server 220 and transmit this to the gateway server 220.

If the settings information for each client device that can be connected to the gateway server 220 is stored in the headend 210, then in order to provide a client device with personalized menus or programs at the request of the client device, the gateway server 220 can request and obtain the settings information for the client device from the headend 210.

The procedures after the gateway server 220 obtains the settings information for the client device are substantially the same as the procedures described for operation 620 and subsequent operations of FIG. 6. As such, redundant descriptions are omitted.

A method of providing personalized services to multiple client devices through a gateway server according to an embodiment of the invention can be implemented in the form of program instructions that may be performed using various computer means and can be recorded in a computer-readable medium. Such a computer-readable medium can include program instructions, data files, data structures, etc., alone or in combination.

The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc.

The hardware mentioned above can be made to operate as one or more software modules that perform the actions of the embodiments of the invention, and vice versa.

While the present invention has been described above using certain preferred embodiments, it is to be appreciated that various modifications and alterations can be made a person having ordinary skill in the art without departing from the spirit and scope of the present invention defined by the scope of claims set forth below.

What is claimed is:

1. A gateway server installed in a home, the gateway server configured to receive live or on-demand programs according to a pre-configured schedule from a headend connected through a network and transmit the received program to one or more client devices positioned in the home, the gateway server comprising:
a settings unit storing settings information for each of the one or more client devices, the settings information including at least one of menus and programs that are available to the respective client devices or are to be blocked to the respective client devices, time information regarding a time during which access is permitted, authorization for payment for a menu or program, viewing restriction age, and viewing time; and
a program provider unit configured to filter and recreate menus and programs according to the settings information for a connected client device, when the one or more client devices are connected, and provide the recreated menus and programs to the client device.

2. The gateway server of claim 1, wherein the program provider unit filters and recreates the menus and programs and transmits the menus and programs to the client device if a connection time of the client device is within the time information, in cases where the settings information includes the time information.

3. The gateway server of claim 1, wherein the authorization for payment is an authorization for payment for a unit program or is an authorization for payment for all programs included in a menu.

4. The gateway server of claim 1, wherein the authorization for payment further includes an age restriction for allowing payment.

5. The gateway server of claim 1, wherein the settings information further includes a setting regarding an authorization for data sharing,
and in cases where the settings information of the client device is configured with the authorization for data sharing, the program provider unit permits a sharing of particular data with another client device or permits an output through the client device of data shared by the other client device.

6. A method of providing personalized services at a gateway server installed in a home and configured to receive live or on-demand programs according to a pre-configured schedule from a headend connected through a network and transmit the received program to one or more client devices positioned in the home, the method comprising:
storing settings information for each of the one or more client devices, the settings information including at least one of menus and programs that are available to the respective client devices or are to be blocked to the respective client devices, time information regarding a time during which access is permitted, authorization for payment for a menu or program, viewing restriction age, and viewing time; and
filtering and recreating menus and programs according to the settings information for a connected client device, when the one or more client devices are connected, and providing the recreated menus and programs to the client device.

7. The method of claim 6, wherein the filtering and recreating of the menus and programs according to the settings information comprises:
filtering and recreating the menus and programs and transmitting the menus and programs to the client device if a connection time of the client device is within the time information, in cases where the settings information includes the time information.

8. The method of claim 6, wherein the authorization for payment is an authorization for payment for a unit program or is an authorization for payment for all programs included in a menu.

9. A computer-readable recorded medium having recorded thereon and tangibly embodying a program of instructions for performing a method according to any one of claim 6, claim 7, and claim 8.
